(19) United States
(12) Patent Application Publication
(10) Pub. No.: US 2025/0214626 A1
(43) Pub. Date: Jul. 3, 2025

(54) TRACK SPAWNING RANGE AND FOG PROXY

(71) Applicant: GM Cruise Holdings LLC, San Francisco, CA (US)

(72) Inventor: Utsav Rajesh Shah, San Jose, CA (US)

(21) Appl. No.: 18/402,425

(22) Filed: Jan. 2, 2024

(51) Int. Cl. B60W 60/00

(52) U.S. Cl. CPC B60W 60/00182; B60W 2420/403; B60W 2420/408

(57) ABSTRACT

The present disclosure generally relates to improved autonomous vehicle (AV) navigation in foggy conditions and, more specifically, to determining a fog intensity level and adjusting the speed of the AV based on the fog intensity level. In some aspects, a method of the disclosed technology includes steps for collecting sensor data for an environment around an AV; determining, based on the collected sensor data, that fog exists in the environment around the AV; determining, based on the collected sensor data, a fog proxy level; determining, based on the fog proxy level, a track spawning range of the AV; and adjusting, based on the track spawning range of the AV, a speed of the AV. Systems and machine-readable media are also provided.

### BACKGROUND

### 1. Technical Field

The present disclosure generally relates to improved autonomous vehicle (AV) navigation in foggy conditions and, more specifically, to determining a fog intensity level and adjusting the speed of the AV based on the fog intensity level.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates a diagram of an example system for adjusting the speed of an AV based on detected fog intensity in the AV's environment, according to some examples of the present disclosure;

FIG. 2 illustrates a process for detecting fog in the environment of an AV and adjusting the speed of the AV based on the fog intensity, according to some examples of the present disclosure;

FIG. 3 illustrates an example system environment that can be used to facilitate autonomous vehicle (AV) dispatch and operations, according to some aspects of the disclosed technology;

FIG. 4 illustrates an example of a deep learning neural network that can be used to determine and improve a correlation between fog intensity values and track spawning ranges, according to some aspects of the disclosed technology; and

FIG. 5 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

Some aspects of the present technology may relate to the gathering and use of data available from various sources to improve safety, quality, and experience. The present disclosure contemplates that in some instances, this gathered data may include personal information. The present disclosure contemplates that the entities involved with such personal information respect and value privacy policies and practices.

An autonomous vehicle (AV) can navigate an environment using data and measurements collected from various sensors mounted on or about the AV. For example, one or more light detection and ranging (LIDAR) sensors, radio detection and ranging (RADAR) sensors, time-of-flight (TOF) sensors, cameras, and/or various other sensors can be mounted on or about the AV to provide data and measurements to an internal computing system of the AV. The internal computing system of the AV can use the data and measurements to control one or more mechanical and/or electrical systems of the AV (such as, for example, a vehicle propulsion system, a braking system, or a steering system, among others).

The sensors can allow the AV to obtain sensor data that measures, describes, and/or depicts one or more aspects of a target such as an object, a scene, a person, and/or any other targets located in the AV's environment. In one example, a LIDAR sensor can be used to determine ranges (variable distance) of one or more targets by directing a laser to a surface of a target (e.g., a person, an object, a structure, an animal, etc.) and measuring the time for light reflected from the surface to return to the LIDAR sensor. In some cases, a LIDAR sensor, such as a spinning LIDAR sensor, can be configured to rotate about an axis of the LIDAR sensor while collecting sensor data for different regions of space. This raw sensor data collected by the LIDAR sensor can comprise LIDAR point cloud data that can be analyzed by one or more computing systems or networks to make determinations about the size, shape, and location of the one or more targets (among other determinations). For example, a computing system of the AV can determine a location (e.g., x, y, z coordinates in space) of one or more targets by analyzing and processing received raw LIDAR point cloud sensor data. Additionally, the shape of the one or more targets can be modeled by a computing system or network based on the received raw LIDAR point cloud sensor data.

In some scenarios, weather conditions in the AV's environment can impact the operation of the various sensors of the AV. For example, the presence of fog in the AV's environment can limit the distance at which a sensor (such as, for example, a LIDAR sensor, a camera, and/or any other optical sensor) can detect an object, a scene, a person, and/or any other target located in the AV's environment. That is, in scenarios where the environment is clear (i.e., no fog), the various sensors can detect target objects located at a greater distance from the AV than in scenarios where fog exists in the environment. In some cases, an increase in fog intensity in the AV's environment can decrease the distance at which target objects can be detected by the sensors. The speed at which the AV can safely travel can be impacted by the distance at which the sensors can detect objects in the AV's environment. For example, human drivers can adjust their speed as fog intensity increases or decreases in order to maintain a safe stopping distance from other objects (or potential objects) in the environment based on how far the human driver can see into the environment at a given time. A safe human driver can slow down as fog intensity increases in order to remain at a safe stopping distance from any objects (or potential objects) located in the environment. However, an AV can lack the human intuition necessary to adjust the speed of an AV in real time based on changing fog intensities, and therefore described herein are systems, apparatuses, processes (also referred to as methods), and computer-readable media (collectively referred to as “systems and techniques”) for detecting fog, determining the fog intensity, and adjusting the speed of the AV as it travels to maintain a safe stopping distance based on the detected fog intensity.

The stopping distance of an AV can be the distance needed to stop the AV once the brakes are applied. In some examples, the faster the AV is travelling, the longer the stopping distance can be. For example, when the brakes are applied to an AV travelling 100 mph, it can take longer for the AV to come to a complete stop than when the brakes are applied to an AV travelling 10 mph. Under clear conditions (i.e., conditions with no fog, for example), AV's can adjust their speed to maintain a stopping distance based on the distance of any objects detected by the sensors in the environment. For example, the further the objects are located from the AV, the faster the AV can safely travel while maintaining a safe stopping distance from those objects. As fog appears in the environment, and fog intensity fluctuates over time, one or more sensors mounted on the AV can detect the fog intensity at a given time, and based on the fog intensity (and, optionally, other considerations), adjust the speed of the AV to maintain a safe stopping distance.

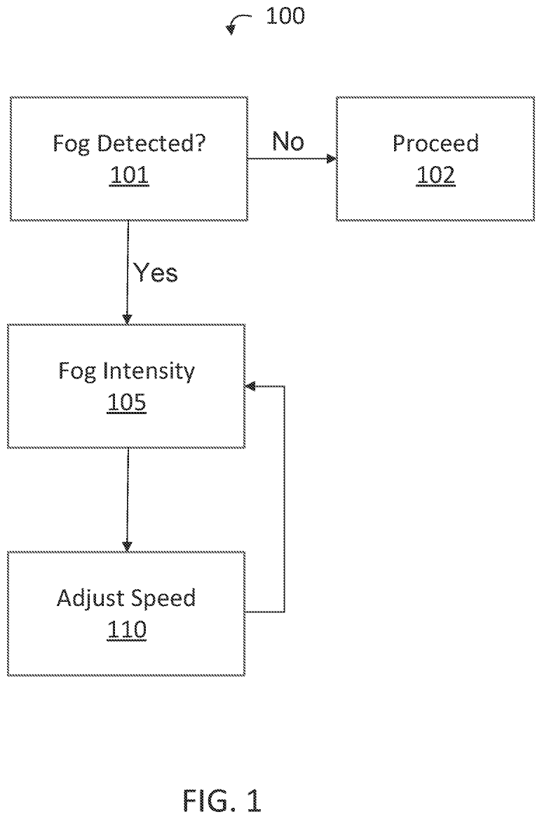

FIG. 1 illustrates a diagram of an example system 100 for adjusting the speed of an AV based on detected fog intensity in the AV's environment. At block 101, one or more sensors mounted on or about the AV can provide collected data to a computing system of the AV to determine whether fog exists in the AV's environment. Fog can comprise polydisperse droplets having diameters on the order of 1 to 100 microns. The one or more sensors mounted on or about the AV can detect these droplets and provide the detected data to a computing system of the AV. The computing system of the AV can then determine whether the detected data indicates the existence of fog in the environment. In some scenarios, this determination of whether fog exits in the AV's environment can be a binary output (for example, “yes” or “no”). In some examples, the determination of whether fog exists in the AV's environment can be a probability that fog exists. Various sensors can be used to determine the existence of fog in the environment including, but not limited to, LIDAR sensors, RADAR sensors, and/or cameras. In some examples, fused sensor data (i.e., sensor data from more than one sensor type) can be used by the AV computing system to make the determination of the existence of fog.

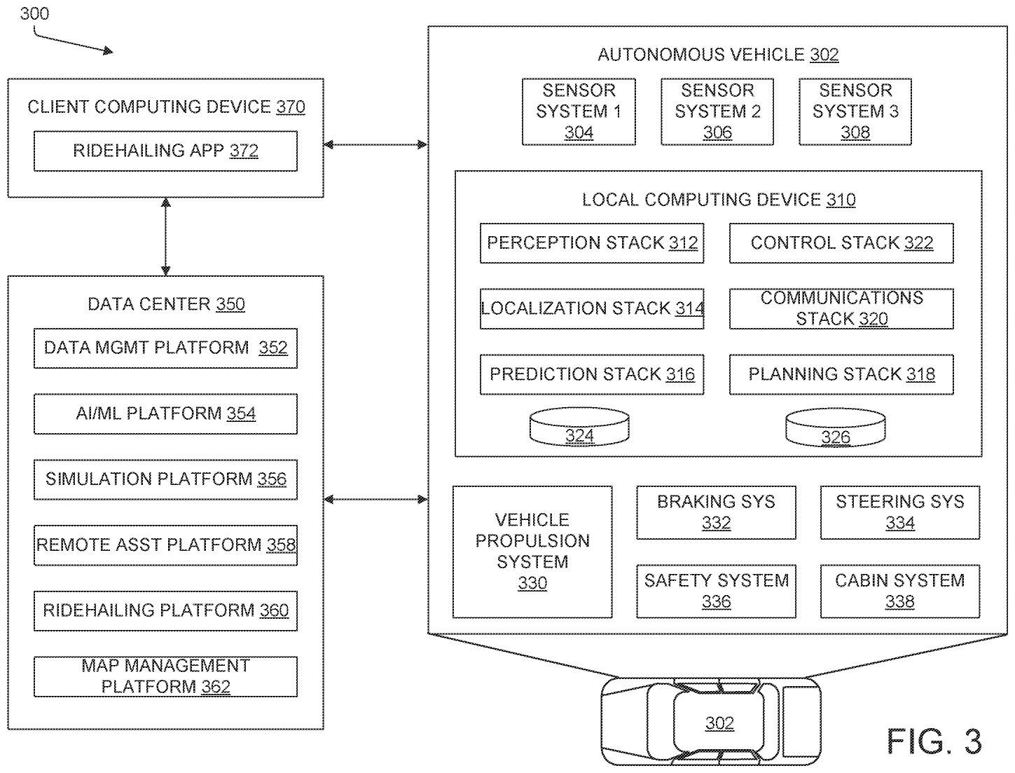

In the scenario where the computing system of the AV determines that there is no fog in the AV's environment, the AV operation will continue as normal (block 102). Normal operation of the AV can include any of the operations discussed below with reference to FIG. 3. For example, in this scenario, no speed adjustment to the AV is made to account for fog in the environment. That is, the AV can proceed as normal, unaffected by fog. However, in the scenario where the computing system of the AV determines that fog exists in the AV's environment, the computing system of the AV can next determine the intensity of the fog (sometimes referred to as a “fog proxy level” or, alternatively as an “FOP level”). The intensity of the fog (i.e., the “fog proxy level” or, alternatively the “FOP level”) can be a measure of the intensity of the fog in the AV's environment at a given time. For example, the more intense the fog, the higher the fog proxy level. The computing system of the AV can make a determination of this fog proxy level based on data received from the one or more sensors mounted on or about the AV. The sensors that can be used to determine the fog proxy level in the environment can include (but are not limited to) LIDAR sensors, RADAR sensors, and/or cameras. In some examples, fused sensor data (i.e., sensor data from more than one sensor type) can be used by the AV computing system to determine the fog proxy level.

In one example embodiment, the determined fog proxy level can be expressed in a numerical value. For example, in one example embodiment, the determined fog proxy level can range from 0 to 20, with 0 indicating no fog in the environment and 20 indicating essentially white-out conditions (i.e., zero vision). While the range of 0 to 20 is provided in this example, it is understood that the fog proxy level can be represented by any suitable numerical range. In some cases, a very low fog proxy level (i.e., less than 0.8) can be considered as clear conditions wherein no speed adjustments are necessary. In some cases, a very high fog proxy level (i.e., more than 6) can be considered too dangerous to drive in, and the AV can be grounded until the fog proxy level falls below a certain threshold value. The fog proxy level can continue to be monitored until it falls below a certain threshold that is considered safe to proceed. In some examples, the fog proxy level can be divided into various levels and given semantic labels that indicate the real-world intensity of the fog (i.e., “no fog,” “very light fog,” “light fog,” “medium fog,” “high fog,” “very high fog,” etc.).

The value of the fog proxy level can be correlated with a track spawning range for the AV. The track spawning range of the AV can be the radial distance at which the AV can confidently detect, track and/or classify target objects located within the AV's environment. In many examples, as the fog intensity value increases, the track spawning range of the AV can decrease. In some examples, but not necessarily all examples, the relationship between the fog intensity value and the track spawning range of the AV can be an inversely proportional relationship. The track spawning range can also be correlated to the stopping distance of the AV. Because the AV may not know if any objects are located outside of the AV's track spawning range, the speed of the AV should be adjusted to permit a stopping distance that is within the current track spawning range of the AV. That way, if any object located outside of the AV's track spawning range is suddenly detected when that object enters the AV's track spawning range, the AV can apply the brakes and safely stop (and avoid a potential collision with the object).

The correlation between the fog intensity value and the track spawning range can be determined based on complex mathematical models. The mathematical models can be determined based on comparing data associated with the fog intensity value with data indicating the AV's track spawning range over time and determining the correlation. In some examples, the process of determining the mathematical models can include using statistical techniques to remove outliers from collected data, understanding the relationship between FOP levels and percentile distributions of track spawning range, using curve fitting and regression analysis to quantitatively measure the relationship while ensuring improved statistical inference, and determining a second degree polynomial that can reduce R-squared (R-squared can indicate how well the data fits the regression model). Once the correlation is determined, a determined fog intensity value can be input into the mathematical model, and the model can calculate and output the track spawning range associated with that fog intensity value. This can be accomplished in real-time as the AV traverses the environment (in order to account for the changing nature of fog). That is, the intensity of fog can change quickly over time and space. In some examples, the computing system of the AV can perform this correlation to determine the track spawning range at specified time intervals (for example, every 0.1 seconds). In some examples, as discussed below, machine learning models can be used to improve the correlation between the fog intensity value and the track spawning range.

Once the computing system of the AV has determined the track spawning range (based on the fog intensity level at that point in time), the computing system of the AV can correlate this determined track spawning range with a speed that will permit the AV a safe stopping distance within the track spawning range once the brakes are applied. In some examples, the chosen stopping distance can also be modified based on the type of target objects detected in the AV's environment. For example, if people or bicycles are detected in the AV's environment, the required stopping distance can be shorter (as an extra precaution) than if other vehicles are detected in the AV's environment. In scenarios where there are both people and other vehicles (and/or other target objects) in the AV's environment, the computing system can select a stopping distance based on the most restrictive target object (for example, people in this scenario). The correlation between the track spawning range and the speed that can permit the AV a safe stopping distance within the track spawning range can be a mathematical model wherein the track spawning range is an input and the speed is the output.

Referring back to FIG. 1, at block 105, the speed determined to safely permit the AV to stop within the determined track spawning range (based on the detected fog intensity value) can be output so that the computing system of the AV can adjust the AV to the determined speed (at block 110). In some embodiments, blocks 101 and 105 can be performed in the perception stack of the AV's computing system (discussed in more detail below), while the speed adjustment at block 110 can be performed in the control stack of the AV's computing system (discussed in more detail below). As the AV continues to traverse the environment at the new speed, the fog intensity can fluctuate. Therefore, the computing system of the AV can continue to monitor the fog intensity level to correlate it with a track spawning range and can continue to determine the appropriate speed that the AV should travel in order to maintain a safe stopping distance from any potential target objects (as indicated by the arrow connecting block 110 to block 105).

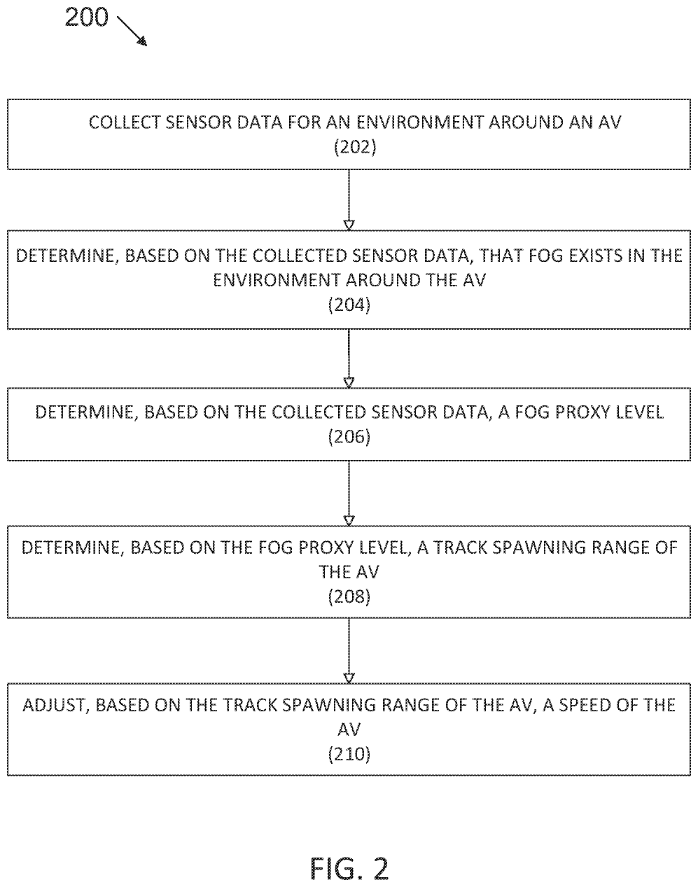

FIG. 2 illustrates a process 200 for detecting fog in the environment of an AV and adjusting the speed of the AV based on the fog intensity. At block 202, the process 200 can include collecting sensor data for an environment around an AV. For example, as discussed above, one or more LIDAR sensors, RADAR sensors, TOF sensors, cameras, and/or various other sensors can be mounted on or about the AV to provide data and measurements to an internal computing system of the AV. The internal computing system of the AV can use the data and measurements to control one or more mechanical and/or electrical systems of the AV (such as, for example, a vehicle propulsion system, a braking system, or a steering system, among others). The sensors can allow the AV to obtain sensor data that measures, describes, and/or depicts one or more aspects of a target such as an object, a scene, a person, and/or any other targets located in the AV's environment. For example, a computing system of the AV can determine a location (e.g., x, y, z coordinates in space) of one or more targets by analyzing and processing received raw sensor data. In some examples, the shape of the one or more targets can be modeled by a computing system or network based on the raw sensor data.

At block 204, process 200 can include determining, based on the collected sensor data, that fog exists in the environment around the AV. For example, the one or more sensors mounted on or about the AV can provide collected data to a computing system of the AV to determine whether fog exists in the AV's environment. As explained above, in some examples, fog can comprise polydisperse droplets having diameters on the order of 1 to 100 microns. The one or more sensors mounted on or about the AV can detect these droplets and provide the detected data to a computing system of the AV. The computing system of the AV can then determine whether the detected data indicates the existence of fog in the environment. In some scenarios, this determination of whether fog exits in the AV's environment can be a binary output (for example, “yes” or “no”). In some examples, the determination of whether fog exists in the AV's environment can be a probability that fog exists. Various sensors can be used to determine the existence of fog in the environment including, but not limited to, LIDAR sensors, RADAR sensors, TOF sensors, and/or cameras. In some examples, fused sensor data (i.e., sensor data from more than one sensor type) can be used by the AV computing system to make the determination of the existence of fog.

At block 206, process 200 can include determining, based on the collected sensor data, a fog proxy level. For example, in the scenario where the computing system of the AV determines that fog exists in the AV's environment, the computing system of the AV can next determine the intensity of the fog (sometimes referred to as a “fog proxy level” or, alternatively as an “FOP level”). The intensity of the fog (i.e., the “fog proxy level” or, alternatively the “FOP level”) can be a measure of the intensity of the fog in the AV's environment at a given time. For example, the more intense the fog, the higher the fog proxy level. The computing system of the AV can make a determination of this fog proxy level based on data received from the one or more sensors mounted on or about the AV. The sensors that can be used to determine the fog proxy level in the environment can include (but are not limited to) LIDAR sensors, RADAR sensors, TOF sensors, and/or cameras. In some examples, fused sensor data (i.e., sensor data from more than one sensor type) can be used by the AV computing system to determine the fog proxy level.

In one example embodiment, the determined fog proxy level can be expressed in a numerical value. For example, in one example embodiment, the determined fog proxy level can range from 0 to 20, with 0 indicating no fog in the environment and 20 indicating essentially white-out conditions (i.e., zero vision). While the range of 0 to 20 is provided in this example, it is understood that the fog proxy level can be represented by any suitable numerical range. In some cases, a very low fog proxy level (i.e., less than 0.8) can be considered as clear conditions wherein no speed adjustments are necessary. In some cases, a very high fog proxy level (i.e., more than 6) can be considered too dangerous to drive in, and the AV can be grounded until the fog proxy level falls below a certain threshold value. The fog proxy level can continue to be monitored until it falls below a certain threshold that is considered safe to proceed. In some examples, the fog proxy level can be divided into various levels and given semantic labels that indicate the real-world intensity of the fog (i.e., “no fog,” “very light fog,” “light fog,” “medium fog,” “high fog,” “very high fog,” etc.).

At block 208, the process 200 can include determining, based on the fog proxy level, a track spawning range of the AV. As discussed above, the value of the fog proxy level can be correlated with a track spawning range for the AV. The track spawning range of the AV can be the radial distance at which the AV can confidently detect and/or classify target objects located within the AV's environment. For example, if the AV can confidently detect and/or classify a target object located at a distance of 20 meters (for example), but cannot confidently detect and/or classify a target object located at a distance of 21 meters, then the track spawning range can be 20 meters in this example. In many examples, as the fog intensity value increases, the track spawning range of the AV can decrease. In some examples, the relationship between the fog intensity value and the track spawning range of the AV can be an inversely proportional relationship. The correlation between the fog intensity value and the track spawning range can be determined based on complex mathematical models. The mathematical models can be determined based on comparing data associated with the fog intensity value with data indicating the AV's track spawning range over time and determining the correlation. Once the correlation is determined, a determined fog intensity value can be input into the mathematical model, and the model can output the track spawning range associated with that fog intensity value. This can be accomplished in real-time as the AV traverses the environment (in order to account for the changing nature of fog). That is, the intensity of fog can change quickly over time and space. In some examples, the computing system of the AV can perform this correlation to determine the track spawning range at specified time intervals (for example, every 0.1 seconds). In some examples, as discussed below, machine learning models can be used to improve the correlation between the fog intensity value and the track spawning range.

At block 210, the process 200 can include adjusting, based on the track spawning range of the AV, a speed of the AV. As discussed above, the track spawning range can be correlated to a stopping distance of the AV. Since the AV may not know if any objects are located outside of the AV's track spawning range, the speed of the AV can be adjusted to permit a stopping distance that is within the current track spawning range of the AV. That way, if any object located outside of the AV's track spawning range is suddenly detected when that object enters the AV's track spawning range, the AV can apply the brakes and safely stop (and avoid a potential collision with the object). Once the computing system of the AV has determined the track spawning range (based on the fog intensity level at that point in time), the computing system of the AV can correlate this determined track spawning range with a speed that will permit the AV a safe stopping distance within the track spawning range once the brakes are applied. In some examples, the chosen stopping distance can also be modified based on the type of target objects detected in the AV's environment. For example, if people or bicycles are detected in the AV's environment, the required stopping distance can be shorter (as an extra precaution) than if other vehicles are detected in the AV's environment. In scenarios where there are both people and other vehicles (and/or other target objects) in the AV's environment, the computing system can select a stopping distance based on the most restrictive target object (for example, people in this scenario). The correlation between the track spawning range and the speed that can permit the AV a safe stopping distance within the track spawning range can be a mathematical model wherein the track spawning range is an input and the speed is the output.

In some examples, the speed determined to safely permit the AV to stop within the determined track spawning range (based on the detected fog intensity value) can be output so that the computing system of the AV can adjust the AV to the determined speed. In some embodiments, the speed adjustment can be performed in the control stack of the AV's computing system (discussed in more detail below). As the AV continues to traverse the environment at the new speed, the fog intensity can fluctuate. Therefore, the computing system of the AV can continue to monitor the fog intensity level to correlate it with a track spawning range and can continue to determine the appropriate speed that the AV should travel in order to maintain a safe stopping distance from any potential target objects.

FIG. 3 is a diagram illustrating an example autonomous vehicle (AV) environment 300, according to some examples of the present disclosure. One of ordinary skill in the art will understand that, for AV environment 300 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 300 includes an AV 302, a data center 350, and a client computing device 370. The AV 302, the data center 350, and the client computing device 370 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 302 can navigate roadways without a human driver based on sensor signals generated by multiple sensor systems 304, 306, and 308. The sensor systems 304-308 can include one or more types of sensors and can be arranged about the AV 302. For instance, the sensor systems 304-308 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 304 can be a camera system, the sensor system 306 can be a LIDAR system, and the sensor system 308 can be a RADAR system. Other examples may include any other number and type of sensors.

The AV 302 can also include several mechanical systems that can be used to maneuver or operate the AV 302. For instance, the mechanical systems can include a vehicle propulsion system 330, a braking system 332, a steering system 334, a safety system 336, and a cabin system 338, among other systems. The vehicle propulsion system 330 can include an electric motor, an internal combustion engine, or both. The braking system 332 can include an engine brake, brake pads, actuators, and/or any other suitable componentry configured to assist in decelerating the AV 302. The steering system 334 can include suitable componentry configured to control the direction of movement of the AV 302 during navigation. The safety system 336 can include lights and signal indicators, a parking brake, airbags, and so forth. The cabin system 338 can include cabin temperature control systems, in-cabin entertainment systems, and so forth. In some examples, the AV 302 might not include human driver actuators (e.g., steering wheel, handbrake, foot brake pedal, foot accelerator pedal, turn signal lever, window wipers, etc.) for controlling the AV 302. Instead, the cabin system 338 can include one or more client interfaces (e.g., Graphical User Interfaces (GUIs), Voice User Interfaces (VUIs), etc.) for controlling certain aspects of the mechanical systems 330-338.

The AV 302 can include a local computing device 310 that is in communication with the sensor systems 304-308, the mechanical systems 330-338, the data center 350, and the client computing device 370, among other systems. The local computing device 310 can include one or more processors and memory, including instructions that can be executed by the one or more processors. The instructions can make up one or more software stacks or components responsible for controlling the AV 302; communicating with the data center 350, the client computing device 370, and other systems; receiving inputs from riders, passengers, and other entities within the AV's environment; logging metrics collected by the sensor systems 304-308; and so forth. In this example, the local computing device 310 includes a perception stack 312, a localization stack 314, a prediction stack 316, a planning stack 318, a communications stack 320, a control stack 322, an AV operational database 324, and an HD geospatial database 326, among other stacks and systems.

Perception stack 312 can enable the AV 302 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 304-308, the localization stack 314, the HD geospatial database 326, other components of the AV, and other data sources (e.g., the data center 350, the client computing device 370, third party data sources, etc.). The perception stack 312 can detect and classify objects and determine their current locations, speeds, directions, and the like. In addition, the perception stack 312 can determine the free space around the AV 302 (e.g., to maintain a safe distance from other objects, change lanes, park the AV, etc.). The perception stack 312 can identify environmental uncertainties, such as where to look for moving objects, flag areas that may be obscured or blocked from view, and so forth. In some examples, an output of the perception stack 312 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

Localization stack 314 can determine the AV's position and orientation (pose) using different methods from multiple systems (e.g., GPS, IMUs, cameras, LIDAR, RADAR, ultrasonic sensors, the HD geospatial database 326, etc.). For example, in some cases, the AV 302 can compare sensor data captured in real-time by the sensor systems 304-308 to data in the HD geospatial database 326 to determine its precise (e.g., accurate to the order of a few centimeters or less) position and orientation. The AV 302 can focus its search based on sensor data from one or more first sensor systems (e.g., GPS) by matching sensor data from one or more second sensor systems (e.g., LIDAR). If the mapping and localization information from one system is unavailable, the AV 302 can use mapping and localization information from a redundant system and/or from remote data sources.

Prediction stack 316 can receive information from the localization stack 314 and objects identified by the perception stack 312 and predict a future path for the objects. In some examples, the prediction stack 316 can output several likely paths that an object is predicted to take along with a probability associated with each path. For each predicted path, the prediction stack 316 can also output a range of points along the path corresponding to a predicted location of the object along the path at future time intervals along with an expected error value for each of the points that indicates a probabilistic deviation from that point.

Planning stack 318 can determine how to maneuver or operate the AV 302 safely and efficiently in its environment. For example, the planning stack 318 can receive the location, speed, and direction of the AV 302, geospatial data, data regarding objects sharing the road with the AV 302 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 302 from one point to another and outputs from the perception stack 312, localization stack 314, and prediction stack 316. The planning stack 318 can determine multiple sets of one or more mechanical operations that the AV 302 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 318 can select from multiple backup plans to carry out. For example, while preparing to change lanes to turn right at an intersection, another vehicle may aggressively cut into the destination lane, making the lane change unsafe. The planning stack 318 could have already determined an alternative plan for such an event. Upon its occurrence, it could help direct the AV 302 to go around the block instead of blocking a current lane while waiting for an opening to change lanes.

Control stack 322 can manage the operation of the vehicle propulsion system 330, the braking system 332, the steering system 334, the safety system 336, and the cabin system 338. The control stack 322 can receive sensor signals from the sensor systems 304-308 as well as communicate with other stacks or components of the local computing device 310 or a remote system (e.g., the data center 350) to effectuate operation of the AV 302. For example, the control stack 322 can implement the final path or actions from the multiple paths or actions provided by the planning stack 318. This can involve turning the routes and decisions from the planning stack 318 into commands for the actuators that control the AV's steering, throttle, brake, and drive unit.

Communications stack 320 can transmit and receive signals between the various stacks and other components of the AV 302 and between the AV 302, the data center 350, the client computing device 370, and other remote systems. The communications stack 320 can enable the local computing device 310 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 320 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 326 can store HD maps and related data of the streets upon which the AV 302 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

AV operational database 324 can store raw AV data generated by the sensor systems 304-308, stacks 312-322, and other components of the AV 302 and/or data received by the AV 302 from remote systems (e.g., the data center 350, the client computing device 370, etc.). In some examples, the raw AV data can include HD LIDAR point cloud data, image data, RADAR data, GPS data, and other sensor data that the data center 350 can use for creating or updating AV geospatial data or for creating simulations of situations encountered by AV 302 for future testing or training of various machine learning algorithms that are incorporated in the local computing device 310.

Data center 350 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 350 can include one or more computing devices remote to the local computing device 310 for managing a fleet of AVs and AV-related services. For example, in addition to managing the AV 302, the data center 350 may also support a ride-hailing service (e.g., a ridesharing service), a delivery service, a remote/roadside assistance service, street services (e.g., street mapping, street patrol, street cleaning, street metering, parking reservation, etc.), and the like.

Data center 350 can send and receive various signals to and from the AV 302 and the client computing device 370. These signals can include sensor data captured by the sensor systems 304-308, roadside assistance requests, software updates, ride-hailing/ridesharing pick-up and drop-off instructions, and so forth. In this example, the data center 350 includes a data management platform 352, an Artificial Intelligence/Machine Learning (AI/ML) platform 354, a simulation platform 356, a remote assistance platform 358, and a ride-hailing platform 360, and a map management platform 362, among other systems.

Data management platform 352 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ride-hailing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 350 can access data stored by the data management platform 352 to provide their respective services.

The AI/ML platform 354 can provide the infrastructure for training and evaluating machine learning algorithms for operating the AV 302, the simulation platform 356, the remote assistance platform 358, the ride-hailing platform 360, the map management platform 362, and other platforms and systems. Using the AI/ML platform 354, data scientists can prepare data sets from the data management platform 352; select, design, and train machine learning models; evaluate, refine, and deploy the models; maintain, monitor, and retrain the models; and so on.

Simulation platform 356 can enable testing and validation of the algorithms, machine learning models, neural networks, and other development efforts for the AV 302, the remote assistance platform 358, the ride-hailing platform 360, the map management platform 362, and other platforms and systems. Simulation platform 356 can replicate a variety of driving environments and/or reproduce real-world scenarios from data captured by the AV 302, including rendering geospatial information and road infrastructure (e.g., streets, lanes, crosswalks, traffic lights, stop signs, etc.) obtained from a cartography platform (e.g., map management platform 362); modeling the behavior of other vehicles, bicycles, pedestrians, and other dynamic elements; simulating inclement weather conditions, different traffic scenarios; and so on.

Remote assistance platform 358 can generate and transmit instructions regarding the operation of the AV 302. For example, in response to an output of the AI/ML platform 354 or other system of the data center 350, the remote assistance platform 358 can prepare instructions for one or more stacks or other components of the AV 302.

Ride-hailing platform 360 can interact with a customer of a ride-hailing service via a ride-hailing application 372 executing on the client computing device 370. The client computing device 370 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ride-hailing application 372. The client computing device 370 can be a customer's mobile computing device or a computing device integrated with the AV 302 (e.g., the local computing device 310). The ride-hailing platform 360 can receive requests to pick up or drop off from the ride-hailing application 372 and dispatch the AV 302 for the trip.

Map management platform 362 can provide a set of tools for the manipulation and management of geographic and spatial (geospatial) and related attribute data. The data management platform 352 can receive LIDAR point cloud data, image data (e.g., still image, video, etc.), RADAR data, GPS data, and other sensor data (e.g., raw data) from one or more AVs 302, Unmanned Aerial Vehicles (UAVs), satellites, third-party mapping services, and other sources of geospatially referenced data. The raw data can be processed, and map management platform 362 can render base representations (e.g., tiles (2D), bounding volumes (3D), etc.) of the AV geospatial data to enable users to view, query, label, edit, and otherwise interact with the data. Map management platform 362 can manage workflows and tasks for operating on the AV geospatial data. Map management platform 362 can control access to the AV geospatial data, including granting or limiting access to the AV geospatial data based on user-based, role-based, group-based, task-based, and other attribute-based access control mechanisms. Map management platform 362 can provide version control for the AV geospatial data, such as to track specific changes that (human or machine) map editors have made to the data and to revert changes when necessary. Map management platform 362 can administer release management of the AV geospatial data, including distributing suitable iterations of the data to different users, computing devices, AVs, and other consumers of HD maps. Map management platform 362 can provide analytics regarding the AV geospatial data and related data, such as to generate insights relating to the throughput and quality of mapping tasks.

In some embodiments, the map viewing services of map management platform 362 can be modularized and deployed as part of one or more of the platforms and systems of the data center 350. For example, the AI/ML platform 354 may incorporate the map viewing services for visualizing the effectiveness of various object detection or object classification models, the simulation platform 356 may incorporate the map viewing services for recreating and visualizing certain driving scenarios, the remote assistance platform 358 may incorporate the map viewing services for replaying traffic incidents to facilitate and coordinate aid, the ride-hailing platform 360 may incorporate the map viewing services into the client application 372 to enable passengers to view the AV 302 in transit en route to a pick-up or drop-off location, and so on.

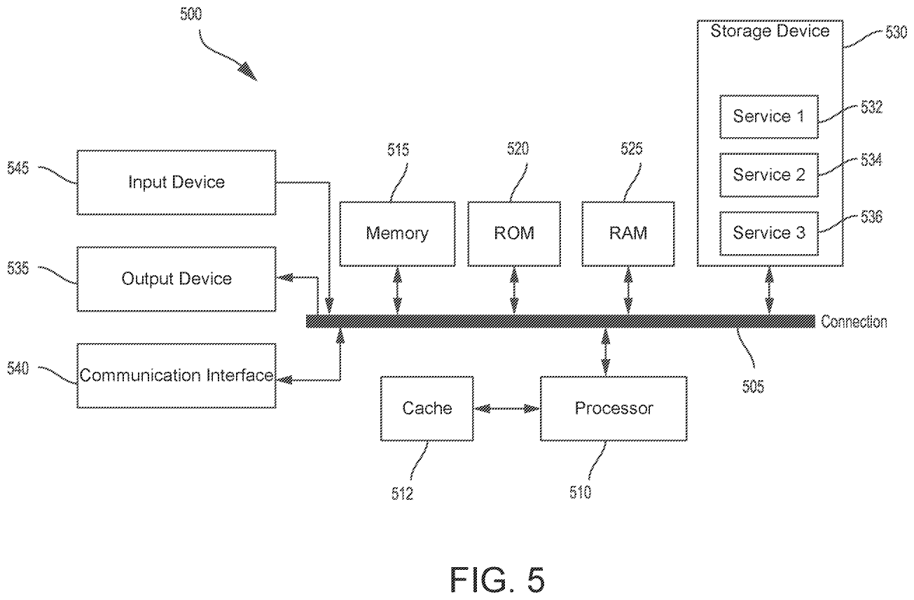

While the autonomous vehicle 302, the local computing device 310, and the autonomous vehicle environment 300 are shown to include certain systems and components, one of ordinary skill will appreciate that the autonomous vehicle 302, the local computing device 310, and/or the autonomous vehicle environment 300 can include more or fewer systems and/or components than those shown in FIG. 3. For example, the autonomous vehicle 302 can include other services than those shown in FIG. 3 and the local computing device 310 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 3. An illustrative example of a computing device and hardware components that can be implemented with the local computing device 310 is described below with respect to FIG. 5.

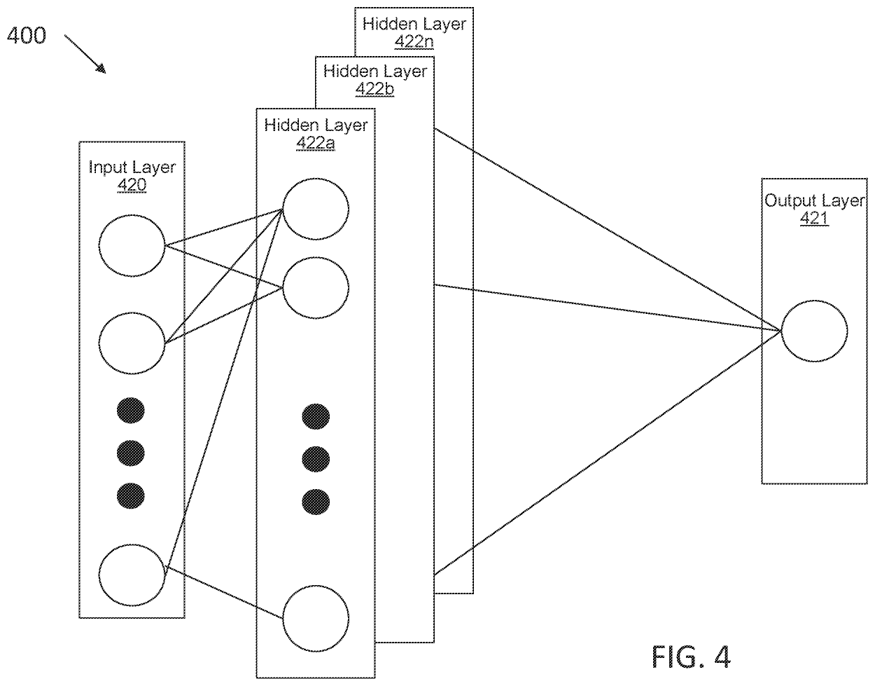

In FIG. 4, the disclosure now turns to a further discussion of models that can be used through the environments and techniques described herein. FIG. 4 is an example of a deep learning neural network 400 that can be used to implement all or a portion of the systems and techniques described herein (e.g., neural network 400 can be used to determine and improve the correlation between the fog intensity values and track spawning ranges, as discussed above). An input layer 420 can be configured to receive sensor data and/or data relating to an environment surrounding an AV. Neural network 400 includes multiple hidden layers 422a, 422b, through 422n. The hidden layers 422a, 422b, through 422n include “n” number of hidden layers, where “n” is an integer greater than or equal to one. The number of hidden layers can be made to include as many layers as needed for the given application. Neural network 400 further includes an output layer 421 that provides an output resulting from the processing performed by the hidden layers 422a, 422b, through 422n.

Neural network 400 is a multi-layer neural network of interconnected nodes. Each node can represent a piece of information. Information associated with the nodes is shared among the different layers and each layer retains information as information is processed. In some cases, the neural network 400 can include a feed-forward network, in which case there are no feedback connections where outputs of the network are fed back into itself. In some cases, the neural network 400 can include a recurrent neural network, which can have loops that allow information to be carried across nodes while reading in input.

Information can be exchanged between nodes through node-to-node interconnections between the various layers. Nodes of the input layer 420 can activate a set of nodes in the first hidden layer 422a. For example, as shown, each of the input nodes of the input layer 420 is connected to each of the nodes of the first hidden layer 422a. The nodes of the first hidden layer 422a can transform the information of each input node by applying activation functions to the input node information. The information derived from the transformation can then be passed to and can activate the nodes of the next hidden layer 422b, which can perform their own designated functions. Example functions include convolutional, up-sampling, data transformation, and/or any other suitable functions. The output of the hidden layer 422b can then activate nodes of the next hidden layer, and so on. The output of the last hidden layer 422n can activate one or more nodes of the output layer 421, at which an output is provided. In some cases, while nodes in the neural network 400 are shown as having multiple output lines, a node can have a single output and all lines shown as being output from a node represent the same output value.

In some cases, each node or interconnection between nodes can have a weight that is a set of parameters derived from the training of the neural network 400. Once the neural network 400 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 400 to be adaptive to inputs and able to learn as more and more data is processed.

The neural network 400 is pre-trained to process the features from the data in the input layer 420 using the different hidden layers 422a, 422b, through 422n in order to provide the output through the output layer 421.

In some cases, the neural network 400 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 400 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½(target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 400 can perform a backward pass by determining which inputs (weights) most contributed to the loss of the network, and can adjust the weights so that the loss decreases and is eventually minimized.

The neural network 400 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 400 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

FIG. 5 illustrates an example processor-based system with which some aspects of the subject technology can be implemented. For example, processor-based system 500 can be any computing device making up, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 500 includes at least one processing unit (Central Processing Unit (CPU) or processor) 510 and connection 505 that couples various system components including system memory 515, such as Read-Only Memory (ROM) 520 and Random-Access Memory (RAM) 525 to processor 510. Computing system 500 can include a cache of high-speed memory 512 connected directly with, in close proximity to, or integrated as part of processor 510.

Processor 510 can include any general-purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 540 may also include one or more Global Navigation Satellite System (GNSS) receivers or transceivers that are used to determine a location of the computing system 500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 530 can include software services, servers, services, etc., that when the code that defines such software is executed by the processor 510, it causes the system 500 to perform a function. In some embodiments, a hardware service that performs a particular function can include the software component stored in a computer-readable medium in connection with the necessary hardware components, such as processor 510, connection 505, output device 535, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Aspect 1. A system comprising: at least one memory; and at least one processor coupled to the at least one memory, the at least one processor configured to: collect sensor data for an environment around an autonomous vehicle (AV); determine, based on the collected sensor data, that fog exists in the environment around the AV; determine, based on the collected sensor data, a fog proxy level; determine, based on the fog proxy level, a track spawning range of the AV; and adjust, based on the track spawning range of the AV, a speed of the AV.

Aspect 2. The system of Aspect 1, wherein the sensor data is collected from at least one of a light detection and ranging (LIDAR) sensor, a radio detection and ranging (RADAR) sensor, a time-of-flight (TOF) sensor, and a camera sensor.

Aspect 3. The system of Aspect 1 or 2, wherein the sensor data comprises fused sensor data.

Aspect 4. The system of any of Aspects 1 to 3, wherein the fog proxy level comprises a value ranging from 0 to 20.

Aspect 5. The system of any of Aspects 1 to 4, wherein the fog proxy level is correlated with the track spawning range based on a mathematical model.

Aspect 6. The system of any of Aspects 1 to 5, wherein the fog proxy level is correlated with the track spawning range using a machine learning model.

Aspect 7. The system of any of Aspects 1 to 6, wherein the speed of the AV is adjusted to a speed correlated with a stopping distance less than a distance of the track spawning range.

Aspect 8. A method comprising: collecting sensor data for an environment around an autonomous vehicle (AV); determining, based on the collected sensor data, that fog exists in the environment around the AV; determining, based on the collected sensor data, a fog proxy level; determining, based on the fog proxy level, a track spawning range of the AV; and adjusting, based on the track spawning range of the AV, a speed of the AV.

Aspect 9. The method of Aspect 8, wherein the sensor data is collected from at least one of a light detection and ranging (LIDAR) sensor, a radio detection and ranging (RADAR) sensor, a time-of-flight (TOF) sensor, and a camera sensor.

Aspect 10. The method of Aspect 8 or 9, wherein the sensor data comprises fused sensor data.

Aspect 11. The method of any of Aspects 8 to 10, wherein the fog proxy level comprises a value ranging from 0 to 20.

Aspect 12. The method of any of Aspects 8 to 11, wherein the fog proxy level is correlated with the track spawning range based on a mathematical model.

Aspect 13. The method of any of Aspects 8 to 12, wherein the fog proxy level is correlated with the track spawning range using a machine learning model.

Aspect 14. The method of any of Aspects 8 to 13, wherein the speed of the AV is adjusted to a speed correlated with a stopping distance less than a distance of the track spawning range.

Aspect 15. A non-transitory computer-readable storage medium comprising at least one instruction for causing a computer or processor to: collect sensor data for an environment around an autonomous vehicle (AV); determine, based on the collected sensor data, that fog exists in the environment around the AV; determine, based on the collected sensor data, a fog proxy level; determine, based on the fog proxy level, a track spawning range of the AV; and adjust, based on the track spawning range of the AV, a speed of the AV.

Aspect 16. The non-transitory computer-readable storage medium of Aspect 15, wherein the sensor data is collected from at least one of a light detection and ranging (LIDAR) sensor, a radio detection and ranging (RADAR) sensor, a time-of-flight (TOF) sensor, and a camera sensor.

Aspect 17. The non-transitory computer-readable storage medium of Aspect 15 or 16, wherein the sensor data comprises fused sensor data.

Aspect 18. The non-transitory computer-readable storage medium of any of Aspects 15 to 17, wherein the fog proxy level comprises a value ranging from 0 to 20.

Aspect 19. The non-transitory computer-readable storage medium of any of Aspects 15 to 18, wherein the fog proxy level is correlated with the track spawning range based on a mathematical model.

Aspect 20. The non-transitory computer-readable storage medium of any of Aspects 15 to 19, wherein the fog proxy level is correlated with the track spawning range using a machine learning model.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A system comprising:
at least one memory; and
at least one processor coupled to the at least one memory, the at least one processor configured to:
collect sensor data for an environment around an autonomous vehicle (AV);
determine, based on the collected sensor data, that fog exists in the environment around the AV;
determine, based on the collected sensor data, a fog proxy level;
determine, based on the fog proxy level, a track spawning range of the AV; and
adjust, based on the track spawning range of the AV, a speed of the AV.

2. The system of claim 1, wherein the sensor data is collected from at least one of a light detection and ranging (LIDAR) sensor, a radio detection and ranging (RADAR) sensor, a time-of-flight (TOF) sensor, and a camera sensor.

3. The system of claim 1, wherein the sensor data comprises fused sensor data.

4. The system of claim 1, wherein the fog proxy level comprises a value ranging from 0 to 20.

5. The system of claim 1, wherein the fog proxy level is correlated with the track spawning range based on a mathematical model.

6. The system of claim 1, wherein the fog proxy level is correlated with the track spawning range using a machine learning model.

7. The system of claim 1, wherein the speed of the AV is adjusted to a speed correlated with a stopping distance less than a distance of the track spawning range.

8. A method comprising:
collecting sensor data for an environment around an autonomous vehicle (AV);
determining, based on the collected sensor data, that fog exists in the environment around the AV;
determining, based on the collected sensor data, a fog proxy level;
determining, based on the fog proxy level, a track spawning range of the AV; and
adjusting, based on the track spawning range of the AV, a speed of the AV.

9. The method of claim 8, wherein the sensor data is collected from at least one of a light detection and ranging (LIDAR) sensor, a radio detection and ranging (RADAR) sensor, a time-of-flight (TOF) sensor, and a camera sensor.

10. The method of claim 8, wherein the sensor data comprises fused sensor data.

11. The method of claim 8, wherein the fog proxy level comprises a value ranging from 0 to 20.

12. The method of claim 8, wherein the fog proxy level is correlated with the track spawning range based on a mathematical model.

13. The method of claim 8, wherein the fog proxy level is correlated with the track spawning range using a machine learning model.

14. The method of claim 8, wherein the speed of the AV is adjusted to a speed correlated with a stopping distance less than a distance of the track spawning range.

15. A non-transitory computer-readable storage medium comprising at least one instruction for causing a computer or processor to:
collect sensor data for an environment around an autonomous vehicle (AV);
determine, based on the collected sensor data, that fog exists in the environment around the AV;
determine, based on the collected sensor data, a fog proxy level;
determine, based on the fog proxy level, a track spawning range of the AV; and
adjust, based on the track spawning range of the AV, a speed of the AV.

16. The non-transitory computer-readable storage medium of claim 15, wherein the sensor data is collected from at least one of a light detection and ranging (LIDAR) sensor, a radio detection and ranging (RADAR) sensor, a time-of-flight (TOF) sensor, and a camera sensor.

17. The non-transitory computer-readable storage medium of claim 15, wherein the sensor data comprises fused sensor data.

18. The non-transitory computer-readable storage medium of claim 15, wherein the fog proxy level comprises a value ranging from 0 to 20.

19. The non-transitory computer-readable storage medium of claim 15, wherein the fog proxy level is correlated with the track spawning range based on a mathematical model.

20. The non-transitory computer-readable storage medium of claim 15, wherein the fog proxy level is correlated with the track spawning range using a machine learning model.
